(19) United States
(12) Patent Application Publication
(10) Pub. No.: US 2012/0128572 A1
(43) Pub. Date: May 24, 2012

(54) METHOD OF PRODUCING CALCIUM CARBONATE

(75) Inventor: Mathias Snare, Pargas (FI)

(73) Assignee: NORDKALK OY AB, Pargas (FI)

(21) Appl. No.: 13/377,689

(22) PCT Filed: Jun. 11, 2010
(86) PCT No.: PCT/FI2010/050488

§ 371 Date: Jan. 26, 2012

(30) Foreign Application Priority Data
Jun. 12, 2009 (FI) 20095672

(51) Int. Cl. C01F 11/18

(52) U.S. Cl. 423/432

(57) ABSTRACT

A method of producing calcium carbonate. In the method a calcium oxide material is contacted in aqueous phase with carbon dioxide in a plurality of carbonation units. According to the invention, the calcium oxide material is carbonated in a first carbonation unit in an aqueous slurry at a pH in excess of 11.0 in order to produce a calcium carbonate into the aqueous slurry, from the first carbonation unit is withdrawn an effluent formed by an aqueous slurry containing calcium carbonate and calcium hydroxide, and the calcium hydroxide of the withdrawn effluent is then carbonated in a second carbonation unit to produce a calcium carbonate slurry having a pH of less than 6.9. The method allows for the production of both monodisperse particles with a narrow molecular weight distripution and multidisperse particles with a broad molecular weight distribution.

### CROSS REFERENCE TO RELATED APPLICATIONS

This application is entitled to the benefit of and incorporates by reference essential subject matter disclosed in International Patent Application No. PCT/FI2010/050488 filed on Jun. 11, 2010 and Finnish Patent Application No. 20095672 filed Jun. 12, 2009.

### TECHNICAL FIELD

The present invention relates to the production of calcium carbonate. In particular, the present invention concerns a method for producing calcium carbonate, preferably precipitated calcium carbonate.

According to a method of the present kind, a calcium oxide raw-material is contacted in aqueous phase with carbon dioxide in a plurality of carbonation units.

### BACKGROUND OF THE INVENTION

Several processes of producing calcium carbonate, which herein is also referred to as precipitated calcium carbonate (PCC), are known in the art. In the prior art solutions, gaseous carbon dioxide is typically bubbled into an aqueous slurry of calcium hydroxide which is mixed in a large tank. The operation of the tank reactor is normally based on the “dose principle” and the production time is 2 to 8 hours, depending on the temperature. The starting point can be calcium oxide, CaO, which is subsequently processed into CaCO₃. However, it is also possible to start with natural limestone, which is calcined in order to break it down into calcium oxide and carbon dioxide.

CaCO₃→CaO+CO₂ 1.

The calcium hydroxide generated after a hydration process of calcium oxide (reaction 2)

CaO+H₂O Ca(OH)₂ 2.

is carbonated into calcium carbonate according to reaction 3

Ca(OH)₂+CO₂CaCO₃+H₂O 3.

In an earlier patent application (WO 2007/057509) we describe an improved set of equipment for producing calcium carbonate in which the carbonation of hydrated calcium oxide is carried out in carbonation units comprising closed reactor vessels, in which the carbonation reaction can be carried out at overpressure. The apparatus is preferably provided with internal circulation, and the recirculated quantity of the product is up to 5 to 20 times greater than the amount of hydrated calcium oxide which is fed into the carbonation unit. Typically, the indicated carbonation unit is a loop reactor. As indicated in WO 2007/057509 it is also possible to arrange a plurality of loop reactors in series or parallel.

By the known process, it is possible to produce particles that have an average particle size of approximately 500 nm at maximum and more than 1 nm. The preferred range is 2-500 nm, especially approximately 10-500 nm.

### SUMMARY OF THE INVENTION

It is an aim of the present invention to provide a novel method of producing calcium carbonate. In particular, it is an aim to provide an alternative carbonation method in which a wide range of calcium carbonate products can be produced basically in one and the same apparatus.

The present invention is based on the idea of carrying out the carbonation in two carbonation zones or units at different pH values. Generally, in the first carbonation zone, the pH is maintained in the alkaline range, whereas in second carbonation zone, the pH is maintained in the acidic or neutral range.

Preferably, the method for the production of calcium carbonate by carbonation of calcium oxide (as such or in hydrated form) in aqueous phase comprises the steps of
withdrawing from the first carbonation unit a slurry containing calcium carbonate and calcium hydroxide and having a pH in excess of 11.0, and
continuing then carbonation of the calcium hydroxide in a second carbonation unit until pH drops below 6.9.

More specifically, the method according to the invention is characterized by carbonating the calcium oxide material in a first carbonation unit in an aqueous slurry at a pH in excess of 11.0 in order to produce a calcium carbonate into the aqueous slurry, withdrawing from the first carbonation unit an effluent formed by an aqueous slurry containing calcium carbonate and calcium hydroxide, the slurry having a pH in excess of 11.5, and carbonating the calcium hydroxide of the withdrawn effluent in a second carbonation unit to produce a calcium carbonate slurry having a pH of less than 6.9.

Considerable advantages are obtained by the present invention. Thus, the present invention makes it possible, in one set of processing apparatus, basically using the same starting materials, to produce products of different kinds—both monodisperse particles with a narrow molecular weight distribution and multidisperse particles with a broad molecular weight distribution. These products can be used for different purposes, such as pigments and fillers in paint, paper, cardboard, rubber and plastics as well as components of various building materials including mixes of hydraulic binders.

Thus, according to one embodiment the invention provides for the production of one pigment or filler grade during a first production period and a second pigment or filler grade during a second production period.

According to a preferred embodiment, the invention is implemented in a reactor cascade comprising at least one loop reactor in the first and optionally also in the second carbonation zone. In this embodiment, the loop reactor provides for high heat transfer rate and allows for operating at pressurized conditions.

### BRIEF DESCRIPTION OF THE DRAWINGS

Further features and advantages of the invention will appear from the following detailed description with working examples. Reference is made to the attached drawings, in which

FIG. 1 is a schematic drawing showing the process configuration of an embodiment of the invention;

FIG. 2 is a schematic drawing showing the process configuration of a another embodiment of the invention;

FIG. 3 is a schematic drawing showing the process configuration of a third embodiment of the invention;

FIG. 4 is a schematic drawing showing the process configuration of a fourth embodiment of the invention;

FIG. 5 is a schematic drawing showing the process configuration of a fifth embodiment of the invention;

FIG. 6 shows the scanning electron microscopy image of the product of Example 1;

FIG. 7 shows the scanning electron microscopy image of the product of Example 2;

FIG. 8 shows the scanning electron microscopy image of the product of Example 3;

FIG. 9 shows the scanning electron microscopy image of the product of Example 4 and FIG. 10 shows the scanning electron microscopy image of the product of Example 5; and

FIG. 11 shows the scanning electron microscopy image of the product of Example 6.

### DETAILED DESCRIPTION OF THE PREFERRED EMBODIMENTS

As already briefly discussed above, the present invention concerns the production of calcium carbonate, in particular precipitated calcium carbonate, by carbonation of a suitable calcium oxide starting material in an aqueous environment. The carbonation process is divided in at least two part which are carried out at different conditions with regard to pH, and optionally also with regard to other processing conditions, such as temperature, pressure and residence time.

During carbonation, the reaction rate is greater in the beginning of the process than later on. According to the present invention, carbonation is therefore first carried out at alkaline conditions during a first period of time, and after the first step, the effluent of the reaction zone is removed and subjected to a second reaction step carried out at acidic conditions during a second period of time. Typically, the first reaction period is shorter than the second. In particular, the ratio between the length of the first reaction period in relation to the length of the second reaction period amounts to 1:1000 to 1:1.5, preferably 1:100 to 1:2.

The starting materials/raw-materials of the process comprise
a source of calcium oxide,
a source of carbon dioxide and
water.

The water used can be conventional process water, optionally deionized by conventional means.

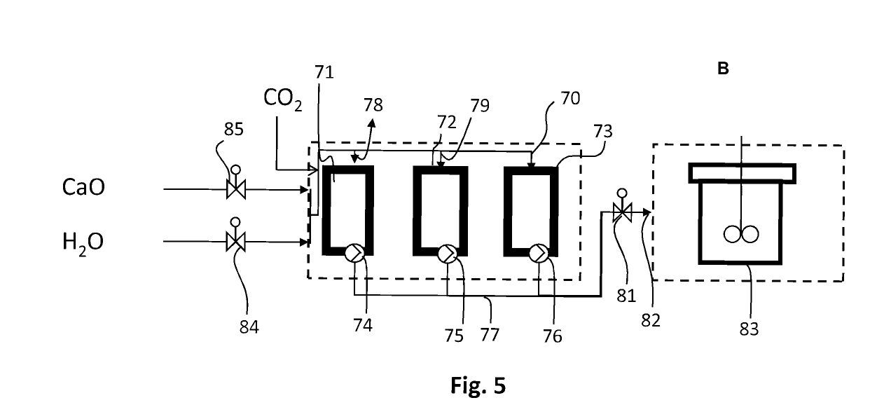

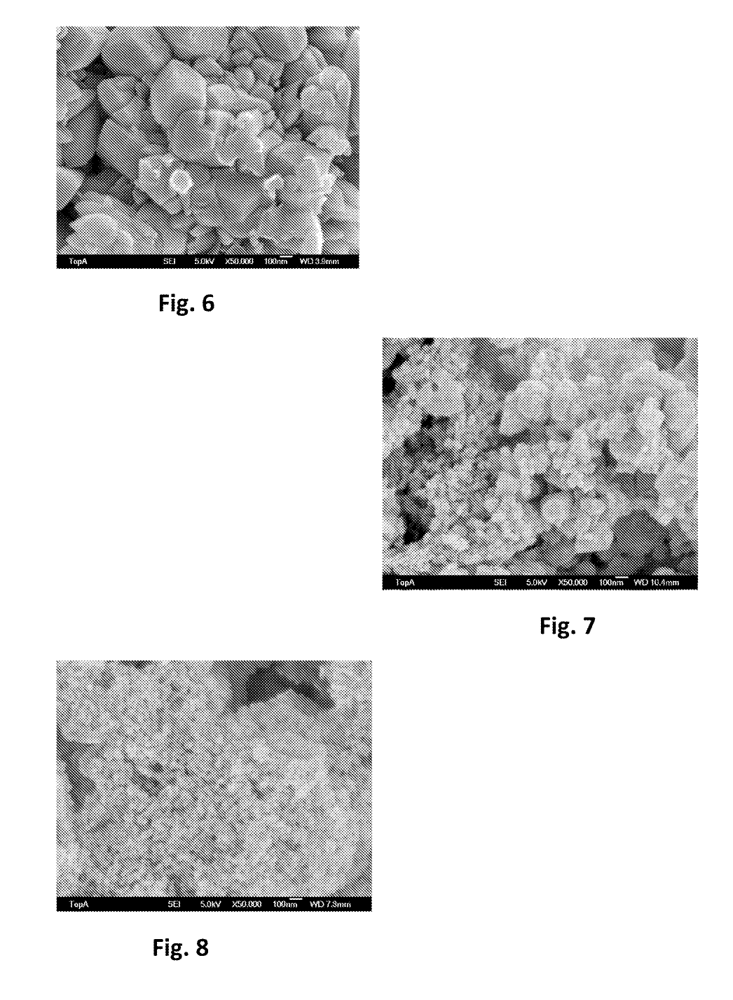

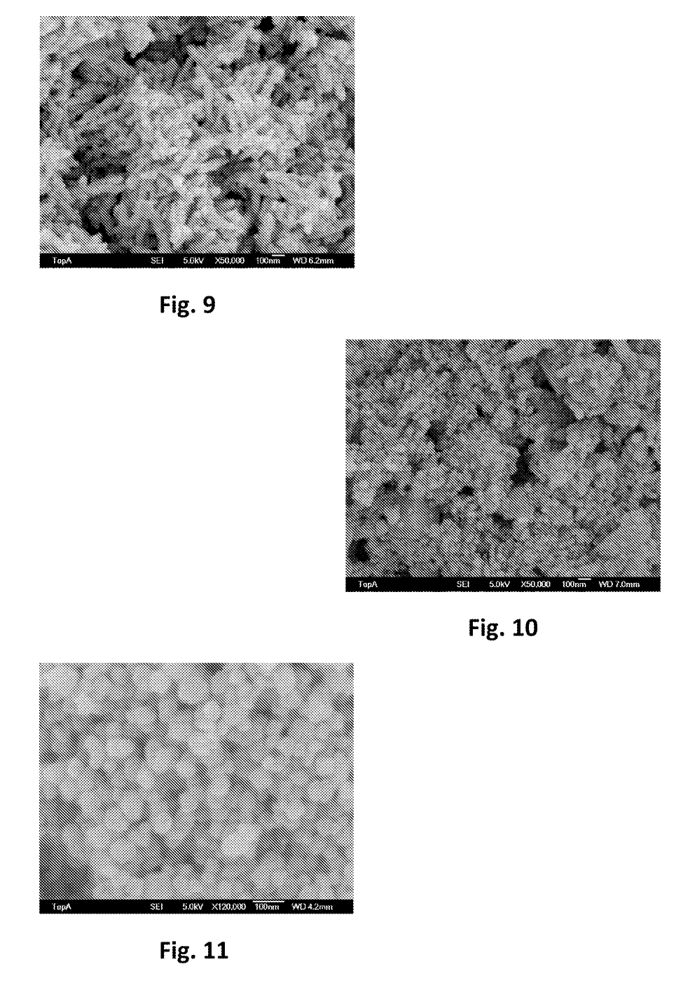

The calcium oxide source is typically derived from a carbonate mineral, such as limestone (CaCO₃), or from a mixture of various carbonate minerals, which can be calcined or combusted (generally “heat treated”) to remove carbon dioxide to provide calcium oxide. The calcium oxide source can comprise the calcined material as such, which then is added in powder form to the first reactor (cf. the embodiment of FIG. 5), or it can comprise a hydratized product, calcium hydroxide (Ca(OH)₂ or slaked lime) which is fed into the first reactor as a slurry. If the calcium oxide is obtained as a powder from calcination, the present reactor equipment can comprise a separate unit, a pretreatment or slaking unit, for slaking of the calcium oxide. This is advantageous from the point of view of heat control since slaking the calcium oxide releases excessive quantities of heat.

Independent on whether the calcium oxide is added as a powder or as slaked lime, an aqueous calcium oxide slurry is formed in the first carbonation unit, wherein the concentration of the calcium oxide is about 2% to about 25%, preferably about 5 to 15%, calculated from the total weight of the total slurry. Additional water can be separately fed into the carbonation unit or the water of the slurry can be provided with the slaked slurry.

A carbon dioxide source is supplied to at least the first carbonation unit. The carbon dioxide source may comprise a gas or a liquid containing or capable of releasing carbon dioxide. Preferably, at least the first and optionally also the second carbonation units are operated in an atmosphere containing carbon dioxide. The carbon dioxide gas can be pure or it can be a gas enriched with carbon dioxide. Examples include air enriched with carbon dioxide, carbon dioxide in gaseous form optionally containing inert gas components, and flue gas. By using excess pressure, the carbon dioxide can be provided in liquid form, optionally even at supercritical conditions.

Typically, the carbonation gas contains at least 5% by volume, preferably at least 10% by volume, in particular about 15 to 100% by volume of carbon dioxide.

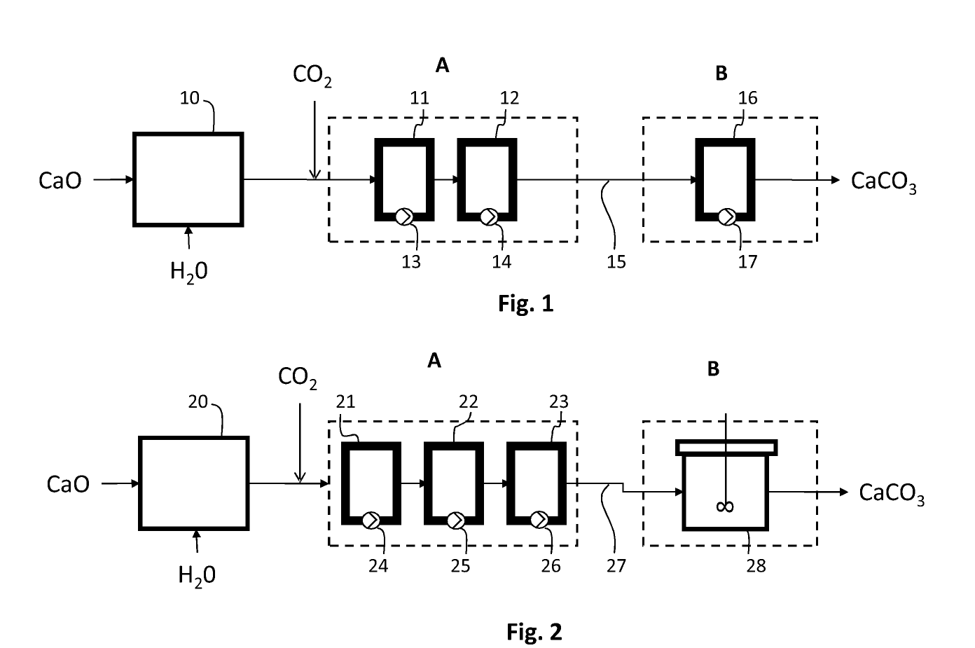

Turning now to the drawings, it can be noted that the following reference numerals are used in FIGS. 1 to 4:
10; 20; 30 and 50 slaker
11, 12; 21-23; 31-33; loop reactors of the first unit
71-73
51-53 plug flow reactors of the first unit
13, 14; 24-26; 34-36; circulation pumps of the loop reactors of the first unit
74-76
16 loop reactor of the second unit
17 circulation pump of the loop reactor of the second unit
28; 43; 63; 83 batch reactors of the second unit
15; 27; 42; 61; 77 conduit for transferring effluent from the first unit to the second unit
18; 29; 44; 64 feed pipe for slaked lime
38-40; 58-60 feed nozzles for slaked lime
70, 72, 78 feed pipes for powderized calcium oxide
54-56; 82 outlet nozzles for effluent of the reactors of the first unit
3, 41, 81; 84; 85 valves

The slakers used for slaking calcium oxide with water, 10, 20, 30 and 50, can comprise any kind of stirred tank reactor preferably provided with cooling/heat recovery in view of the intensely exothermic character of the slaking reaction. The slurry formed in the slaker is fed into the first carbonation zone or unit, which has been given the designation “A” in the attached drawings. The second carbonation zone or unit has been given the designation “B” in the drawings.

For the sake of simplicity, the carbon dioxide feed to the process is indicated with an arrow pointed at the feed pipe 18; 29; 44; 64 of the first unit A. It should be noted, however, as will be explained below, that the carbon dioxide can be fed into both the first and the second units and that the carbon dioxide can be fed into each of the reactors separately, or it can be fed into just one of the carbonation reactors.

The reaction units A and B can be operated as batch reactors, as continuously operated reactors or as semibatch reactors. According to one preferred embodiment, the first unit is operated continuously. According to another embodiment, the second unit is operated continuously. According to a third embodiment, the second unit is operated batchwise.

Each of the carbonation units, in particular the first carbonation unit, can comprise just one reactor or, preferably, a cascade comprising at least two reactors, preferably two to ten reactors. The reactors can also be arranged in parallel or in serial/parallel arrangement, although it is generally preferred to operate at least the main part of the reactors as a cascade.

As will appear, the present invention can be carried out in a combination of 1 to 10 or more first reactors and 1 to 10 or more second reactors.

“Cascade” means that the effluent of a preceding reactor forms the inlet or feed of the next reactor.

One particularly preferred embodiment of the present invention comprises using a loop reactor, or rather a cascade of at least two loop reactors, 11, 12, in the first and a loop reactor 16 in the second phase of the process. This embodiment is illustrated in FIG. 1.

In connection with the present invention, it has been found that the loop reactor is a particularly useful reactor for the present purpose due to the homogeneous and efficient mixing provided by it. The efficient mixing minimizes the formation of temperature and concentration gradients. The process can be controlled and adjusted such as to achieve the desired product or product distribution. The efficient mixing is suitable for the carbonation reaction since it takes place in all aggregation states.

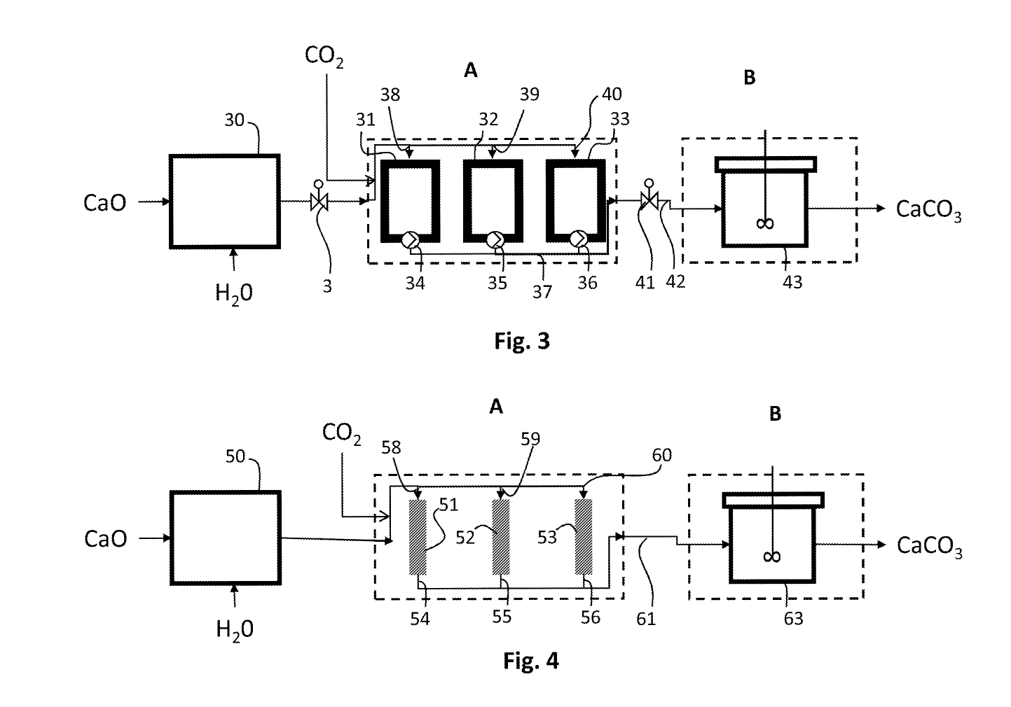

It is possible to provide each reactor unit with internal recirculation as shown in FIG. 1 (reference numerals 13, 14 and 17). It is also possible to arrange internal recirculation only to the loop reactors, cf. FIG. 2 (reference numerals 24 to 26) and FIG. 3 (reference numerals 34 to 36). This means that merely a part of the effluent is fed into the next reactor or, in case of batchwise operation, none of it.

According to one embodiment, each of the above identified carbonation units comprises a plurality of loop reactors. These can be arranged into a cascade or in parallel or in a cascade in which some of the reactors are arranged in parallel with other reactors to allow for maintenance of the reactors without interruption of the operation.

FIG. 2 shows an embodiment similar to the one of FIG. 1 with the exception that the first unit comprises three loop reactors in a cascade 24 to 26, and the second reaction unit comprises a batch reactor, viz. a stirred tank reactor 28. The second reactor can also be a storage tank.

In both embodiments, the slaked lime is fed into the first reactor 13; 24 of the reactor cascade of the first unit A, and the effluent from the last reactor 14; 26 of that unit is directly conducted into the reactor 17; 28 of the second unit B.

According to a further embodiment, the first unit is operated as a batch reactor and the second in batch or continuous mode. The batch reactor of the first unit can be a stirred tank reactor of the kind explained above in conjunction with unit B in FIG. 2, but it can also be formed by at least one loop reactor operated in a batchwise manner. This embodiment is illustrated in FIG. 3 which shows three parallel loop reactors 31 to 33, each being provided with separate inlet nozzles 38 to 40 for the slaked lime and with internal circulation to allow for batchwise operation. The reactors can be independently emptied by an outtake arranged in connection with the circulation pumps 34 to 36 Naturally it is also possible to operate each of the loop reactors of unit A of FIGS. 1, 2 and 4 batchwise.

FIG. 4 shows still a fourth embodiment, wherein the reactors of the first unit are formed by plug flow reactors 51 to 53.

FIG. 5 shows a fifth embodiment, similar to the one of FIG. 3, with the difference that there is no slaking unit before the processing reactors of reaction zone A and B. Rather, the calcium oxide is fed in dry, powderized form directly via conduits 78, 72 and 73 into the first reaction unit comprising loop reactors 71 to 73, with circulation pumps 74 to 76. The first reaction unit can be operated batchwise, as will be explained in connection with Example 6, but naturally also continuous processing is possible. The effluent of the loop reactors is conducted via conduit 77 to the second unit which can be a batch reactor 83 as shown in FIG. 5. The flow of the lime/calcium carbonate slurry is regulated with a valve and the feed nozzle can be situated at any suitable location with respect to the batch reactor (at any height, below or above the surface of the stirred mixture in the reactor).

As explained in connection with Example 6, operating the reactor configuration of FIG. 5 as two batchwise processes in a cascade, a monodisperse product can be produced.

In all of the above embodiments, as well as generally in the process according to the invention, the reaction conditions, such as temperature, pressure and residence time, can vary freely.

In one embodiment, which can be combined with any of the preceding ones and in particular with those in which loop reactors are used, the carbonation reaction is carried out at pressurized conditions in at least one of the carbonation units. In particular, the carbonation reaction is carried out at an overpressure of 0.1 to 25 bar, in particular about 0.5 to 10 bar.

Generally—and in any of the above embodiments—the residence time for the calcium oxide material is short in the first carbonation unit A. Typically, it is about 0.1 to 1000 seconds, in particular about 1 to 300 seconds therein.

According to one embodiment, the residence time for the calcium hydroxide is longer than about 1 minute in the second carbonation unit B. Thus, the residence time for the calcium hydroxide can be longer than about 3 minutes, in particular longer than about 5 minutes in the second carbonation unit. This holds true for, particularly, a second carbonation unit comprising a storage tank.

By controlling pH, degree of carbonation and the residence time for the reactants in the first and second reaction stage, A and B, respectively, it is possible to adjust the quality of the products. According to one embodiment, the residence time of calcium hydroxide is longer than about 30 minutes in the second carbonation unit for producing a monodisperse calcium carbonate product. In particular, the residence time for the calcium hydroxide is about 0.1 to 100 hours in the second carbonation unit for producing a monodisperse calcium carbonate product.

As discussed above, several different kinds of calcium carbonate materials can be produced by the present process. Thus, in one embodiment, from the second carbonation unit is withdrawn and optionally recovered a calcium carbonate slurry containing calcium carbonate particles having an average particle size in the range of 40 to 1000 nm.

In that case, preferably from the first carbonation unit a slurry is withdrawn which contains 5 to 50% by weight unreacted calcium hydroxide, and carbonation is then continued in the second carbonation unit essentially to completion of the carbonation reaction.

The calcium carbonate particles withdrawn from the second carbonation unit has a broad particle size distribution between 40-2000 nm.

Another embodiment comprises operating the first carbonation unit batchwise in order to carbonate at least 90% of the calcium oxide material, on a molar base, and continuing the carbonation of a calcium carbonate slurry withdrawn from the first carbonation unit to produce a calcium carbonate slurry containing calcium carbonate particles having an average particle size in the range of 40 to 90 nm.

The calcium carbonate particles withdrawn from the second carbonation unit have then typically a narrow particle size distribution, wherein the portion of particles greater than 120 nm is less than 20%, in particular less than 10% by the weight of all particles.

According to one embodiment, the present process produces crystalline calcium carbonate particles, typically calcite or vaterite.

The following non-limiting examples illustrate the invention.

### EXAMPLE 1

An experiment was carried out in a continuous stirred tank slaker and a loop-reactor carbonation setup. 300 g/min of quicklime and 3 l/min of water was added to the lime slaker pulse wise depending on the effectiveness of the carbonation units. The temperature of the slaker was kept at 90° C. In the first carbonation unit the slurry and CO₂—gas reacted under 6 bars of pressure. 58% of the carbonation occurred in the first unit, comprising of one loop reactor, the residence time was adjusted according to the extent of carbonation. After carbonation in first unit the lime mixture continued to the second unit where the final carbonation took place. The pH in the first and second unit was 11.4 and 6.2, respectively. The carbonation temperature was kept below 40° C.

The particle size varied between 50-1000 nm with d_{90%}<750 nm based on scanning electron microscopy images, as can be seen from FIG. 1.

### EXAMPLE 2

In a procedure similar to the one presented in Example 1, with exception of the first unit which comprised of multiple loop-reactors coupled in series, was tested. A lime slurry containing 68 g/l Ca(OH)₂ was fed to the first unit, where pH was above 11.6 and >80% of the carbonation took place with a residence time below 2 min. The final carbonation occurred in the second unit at pH 6.3, thereafter the product was withdrawn.

The product particle size varied between 50-1000 nm with d_{90%} ˜400 nm based on scanning electron microscopy images, as can be seen from FIG. 2.

### EXAMPLE 3

A carbonation experiment was conducted by operating the first carbonation unit batchwise in alkaline conditions (pH 11.6) and the second unit in continuous mode operating at a pH level of 6.3. A slurry of 68 g Ca(OH)₂/l was fed to the first unit comprising of multiple loop-reactors. The reaction proceeded until 8% Ca(OH)₂ remained unreacted. Thereafter the slurry mix was transported to the second unit for final carbonation.

The outcome was a monodisperse product with a particle size around 50 nm (based on scanning electron microscopy images, see FIG. 3).

### EXAMPLE 4

A carbonation experiment was conducted by operating the first carbonation unit continuously and the second unit in batch mode. A slurry of 68 g Ca(OH)₂/l was fed to the first unit comprising of loop-reactors. The reaction proceeded in alkaline environment at pH 11.6 until 40% conversion with a residence time >0.25 minutes. Thereafter the slurry mix was transported to the second unit for final carbonation from alkaline pH to pH below 6.5.

The product comprises of needlelike particles with a particle size between 50-500 nm (based on scanning electron microscopy images, see FIG. 4).

### EXAMPLE 5

A carbonation experiment was carried out in a first unit comprising of a tubular reactor setup and a second unit comprising of a batch reactor. A slurry of 42 g Ca(OH)₂/l was fed and partly carbonated (95% of conversion) in the first unit. Thereafter the slurry was fed to the second unit for final carbonation from alkaline pH to pH below 6.5.

The product particle size was between 50-1000 nm (based on scanning electron microscopy images, see FIG. 5).

### EXAMPLE 6

A procedure similar to the one presented in Example 3, without any separate slaking process (cf. FIG. 5), was tested. 50 g lime (CaO)/l(H₂O) was directly carbonated batchwise in a tubular reactor setup. The pH was above 11.6 during carbonation in the first unit. The final carbonation occurred in the second unit where pH was around 6.3.

The outcome was a monodisperse product with a particle size around 50 nm (based on scanning electron microscopy images, see FIG. 11).

While the present invention has been illustrated and described with respect to a particular embodiment thereof, it should be appreciated by those of ordinary skill in the art that various modifications to this invention may be made without departing from the spirit and scope of the present invention.

What is claimed is:

1-32. (canceled)

33. A method of producing calcium carbonate, according to which method a calcium oxide material is contacted in aqueous phase with carbon dioxide in a plurality of carbonation units, wherein:
carbonating the calcium oxide material in a first carbonation unit in an aqueous slurry at a pH in excess of 11.0 in order to produce a calcium carbonate into the aqueous slurry,
withdrawing from the first carbonation unit an effluent formed by an aqueous slurry containing calcium carbonate and calcium hydroxide, the slurry having a pH in excess of 11.5, and
carbonating the calcium hydroxide of the withdrawn effluent in a second carbonation unit to produce a calcium carbonate slurry having a pH of less than 6.9.

34. The method according to claim 33, comprising withdrawing from the first carbonation unit a slurry having a pH in the range of about 12.0 to 13.0.

35. The method according to claim 33, comprising carbonating the calcium hydroxide in the second carbonation unit until a pH of less than 6.5, in particular a pH in the range from 5.5 to 6.3, is reached.

36. The method according to claim 33, wherein the first carbonation unit comprises a calcium oxide slurry, wherein the concentration of the calcium oxide is about 2% to about 25%, preferably about 5 to 15%, calculated from the total weight of the total slurry.

37. The method according to claim 33, comprising providing a carbon dioxide source in at least the first carbonation unit.

38. The method according to claim 37, wherein the carbon dioxide source comprises a gas or a liquid containing carbon dioxide.

39. The method according to claim 33, comprising operating at least the first and optionally also the second carbonation units in an atmosphere containing carbon dioxide.

40. The method according to claim 37, comprising providing a gas containing at least 5% by volume, preferably at least 10% by volume, in particular about 15 to 100% by volume of carbon dioxide.

41. The method according to claim 37, wherein the gas is selected from air enriched with carbon dioxide, carbon dioxide in gaseous form optionally containing inert gas components, and flue gas.

42. The method according to claim 33, comprising operating the first unit as a batch reactor.

43. The method according to claim 33, comprising operating the first unit continuously.

44. The method according to claim 33, wherein the first carbonation unit comprises a cascade of at least two reactors, preferably two to ten reactors.

45. The method according to claim 33, comprising using at least one loop reactor as a carbonation unit.

46. The method according to claim 45, wherein each carbonation unit comprising a plurality of loop reactors.

47. The method according to claim 33, comprising withdrawing from the second carbonation unit a calcium carbonate slurry containing calcium carbonate particles having an average particle size in the range of 40 to 1000 nm.

48. The method according to claim 47, comprising continuously withdrawing from the first carbonation unit a slurry containing 5 to 50% by weight unreacted calcium hydroxide, and continuing carbonation in the second carbonation unit essentially to completion of the carbonation reaction.

49. The method according to claim 47, wherein the calcium carbonate particles withdrawn from the second carbonation unit has a broad particle size distribution, wherein 20% of particles are below 240 nm and 80% of all particles are below 1300 nm.

50. The method according to claim 47, comprising operating the first carbonation unit batchwise in order to carbonate at least 90% of the calcium oxide material, on a molar base, and continuing the carbonation of a calcium carbonate slurry withdrawn from the first carbonation unit to produce a calcium carbonate slurry containing calcium carbonate particles having an average particle size in the range of 40 to 90 nm.

51. The method according to claim 50, wherein the calcium carbonate particles withdrawn from the second carbonation unit has a narrow particle size distribution, wherein the portion of particles greater than 120 nm is less than 20% , in particular less than 10% by the weight of all particles.

52. The method according to claim 47, comprising operating the first and the second carbonation units continuously.

53. The method according to claim 47, comprising operating the first unit as a batch reactor and the second in batch or continuous mode.

54. The method according to claim 53, wherein the second reactor is a storage tank.

55. The method according to claim 33, wherein crystalline calcium carbonate particles are produced.

56. The method according to claim 33, wherein the carbonation reaction is carried out at pressurized conditions in at least one of the carbonation units.

57. The method according to claim 56, wherein the carbonation reaction is carried out at an overpressure of 0.1 to 25 bar, in particular about 0.5 to 10 bar.

58. The method according to claim 33, wherein the residence time for the calcium oxide material is about 0.1 to 1000 seconds, in particular about 1 to 300 seconds in the first carbonation unit.

59. The method according to claim 33, wherein the residence time for the calcium hydroxide is longer than about 1 minute in the second carbonation unit.

60. The method according to claim 59, wherein the residence time for the calcium hydroxide is longer than about 3 minutes, in particular longer than about 5 minutes in the second carbonation unit.

61. The method according to claim 59, wherein the residence time for the calcium hydroxide is longer than about 30 minutes in the second carbonation unit for producing a monodisperse calcium carbonate product.

62. The method according to claim 59, wherein the residence time for the calcium hydroxide is about 0.1 to 100 hours in the second carbonation unit for producing a monodisperse calcium carbonate product.

63. The method according to claim 33, wherein calcium hydroxide is used as a calcium oxide material in the first carbonation unit.

64. The method according to claim 33, wherein calcium oxide, preferably in the form of calcium oxide powder, is used as a calcium oxide material in the first carbonation unit.
